(19) United States
(12) Patent Application Publication
(10) Pub. No.: US 2008/0018621 A1
(43) Pub. Date: Jan. 24, 2008

(54) TOUCH STICK CONTROLLER USING CAPACITANCE TOUCHPAD CIRCUITRY AS A MEASUREMENT SYSTEM

(76) Inventors: Paul Vincent, Fruit Heights, UT (US); Joseph Harris, West Jordan, UT (US)

Correspondence Address: MORRISS OBRYANT COMPAGNI, P.C., 734 EAST 200 SOUTH, SALT LAKE CITY, UT, 84102, US

(21) Appl. No.: 11/778,760

(22) Filed: Jul. 17, 2007

Related U.S. Application Data
(60) Provisional application No. 60/807,902, filed on Jul. 20, 2006.

(51) Int. Cl. G06F 3/033; G01L 1/00

(52) U.S. Cl. 345/184; 73/862.68

(57) ABSTRACT

Capacitance-sensitive touchpad circuitry used for detecting and tracking an object on the surface of a touchpad now receives as inputs to the circuitry the voltage divider signals from each axis of a strain gauge used as a touch stick input device, wherein the touchpad circuitry is far less sensitive to noise, and wherein touch stick control circuitry can be eliminated through the use of existing touchpad circuitry.

### CROSS REFERENCE TO RELATED APPLICATIONS

This document claims priority to and incorporates by reference all of the subject matter included in the provisional patent application docket number 3751.CIRQ.PR, having Ser. No. 60/807,902 and filed on Jul. 20, 2006.

### BACKGROUND OF THE INVENTION

1. Field of the Invention

This invention relates generally to strain gauges that utilize a measurement system that relies on measuring variable voltages. More specifically, the invention relates to a touch stick commonly used as a cursor control device in notebook computers, wherein capacitance measurement circuitry used for operation of a capacitance-sensitive touchpad is used in place of the voltage measuring circuitry.

2. Description of Related Art

Many electronic appliances require input that is provided by small hand or finger manipulation of various controls. These control devices are known to those skilled in the art as touchpads, joysticks, touch sticks and trackballs. Each device can replace the other in at least the most basic of functions. These functions include, but should not be considered limited to, manipulation of a cursor, scrolling through a list or moving a target reticule. Typically, precision control or manipulation is required to operate the control devices in order to perform the desired function.

It is noted that while the basic functions can be performed by all of the listed control devices, some of the control devices are considered superior to the other control devices. In many cases, people tend to have strong preferences of one control device over another. Furthermore, it is also accepted that the control devices are not equal, and some can provide many functions that the others do not.

The present invention deals with two of these control devices in particular. Specifically, the present invention is directed to a touch stick and to a touchpad.

A touchpad generally has a flat surface that is operated by a user touching the surface with a finger or stylus and then sliding the finger or stylus along the surface. Touchpads are generally ubiquitous in portable electronic appliances such as notebook computers, but are also found as accessories or are integrated directly into non-portable devices.

A touch stick can also be used in many of the same devices where a touchpad is used. A touch stick is typically a stationary knob or button, and is often disposed in the middle of keyboard in a notebook computer. A user makes contact with the touch stick and then applies pressure. A touch stick is able to determine the direction from which pressure is being applied, and the amount of pressure that is being applied.

It is generally not important to the present invention whether or not a preference is held for one control device or another. What is relevant is that there is a demand for both of these devices. What is also relevant is that the systems and methods used to receive input from these devices can be improved so that more accurate and reliable operation can be obtained. It is therefore useful to describe the state of the art in control circuitry for each of these control devices so that deficiencies can be clearly understood.

The state of the art in touch stick circuitry is shown in FIG. 1. The touch stick circuitry is essentially divided into two separate but identical circuits 12 and 16. A voltage divider 10, 14 is created for the vertical axis circuit 12 and horizontal axis circuit 16 of a touch stick. A 5V source 18 is provided for each voltage divider 10, 14. It is important to notice that signals 20, 22 and 24, 26 need to be amplified. Using the values shown in these circuits, the gain from the amplifier of the signals 20, 22 and 24, 26 is approximately 400. As a result of this significant amount of signal amplification, the touch stick circuits are very sensitive to noise.

Another source of error in a signal obtained from touch stick circuitry is from offsets in the touch stick voltage divider, as well as drift is resistor values over usage duration.

It should be noted that the touch stick circuits 12, 16 can be modified and still perform the same function. But it is generally the case that touch stick circuits are susceptible to noise because of the high gain used to boost the signals that are obtained.

It is useful to think of touch stick circuitry as essentially performing the function of a strain gauge. The pressure applied to the touch stick is measured so that an associated object, such as a computer cursor, can be moved at a certain rate as determined by the amount of pressure being applied to the touch stick.

It is worth noting that there are other systems and methods that can operate as a strain gauge. For example, a Wheatstone bridge is another circuit configuration for accomplishing the functions performed by the touch stick circuitry.

Accordingly, what is needed is a better way to measure the amount of force that is being applied to the touch stick using the signals that are generated by a voltage divider, but without amplifying noise that is generally going to be present in the signals. In more general terms, what is needed is a more accurate and reliable system and method for measuring pressure applied to an object. It is noted that the voltage divider circuits are generally going to be part of the touch stick circuitry. Accordingly, it would be an advantage to be able to use existing touch sticks without modification.

Before describing the operation of the present invention, it is now useful to describe typical operation of a touchpad and the circuitry that enables it to function.

FIG. 2 is provided as a block diagram of a typical touchpad as provided by CIRQUE® Corporation. The CIRQUE® Corporation touchpad is a mutual capacitance-sensing device and an example is illustrated as a block diagram in FIG. 2. In this touchpad 40, a grid of X (42) and Y (44) electrodes and a sense electrode 46 is used to define the touch-sensitive area 48 of the touchpad. Typically, the touchpad 40 is a rectangular grid of approximately 16 by 12 electrodes, or 8 by 6 electrodes when there are space constraints. Interlaced with these X (42) and Y (44) (or row and column) electrodes is a single sense electrode 46. All position measurements are made through the sense electrode 46.

The CIRQUE® Corporation touchpad 40 measures an imbalance in electrical charge on the sense line 46. When no pointing object is on or in proximity to the touchpad 40, the touchpad circuitry is in a balanced state, and there is no charge imbalance on the sense line 46. When a pointing object creates imbalance because of capacitive coupling when the object approaches or touches a touch surface (the sensing area 48 of the touchpad 40), a change in capacitance occurs on the electrodes 42, 44. What is measured is the change in capacitance, but not the absolute capacitance value on the electrodes 42, 44. The touchpad 40 determines the change in capacitance by measuring the amount of charge that must be injected onto the sense line 46 to reestablish or regain balance of charge on the sense line.

In the first step, a first set of row electrodes 42 are driven with a first signal from P (positive), N (negative) generator 22, and a different but adjacent second set of row electrodes are driven with a second signal from the P, N generator. The touchpad circuitry 20 obtains a value from the sense line 46 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 42 to be driven. In other words, the electrode on one side of the group is added, while the electrode on the opposite side of the group is no longer driven. The new group is then driven by the P, N generator 22 and a second measurement of the sense line 46 is taken.

From these two measurements, it is possible to determine on which side of the row electrode the pointing object is located, and how far away. Pointing object position determination is then performed by using an equation that compares the magnitude of the two signals measured.

More specific detail regarding P and N signals is important to understand. Electrodes are stimulated either as P (positive), or N (negative). The electrodes are capacitively coupled to the voltage regulated sense line or sense electrode. When the voltage potential of the P and N electrodes are toggled, the amount of charge required to be transferred by the sense electrode in order to maintain its voltage is ratio-metrically represented to an internal integration circuit to thereby obtain a digital value. The digital value is thus proportional to the value of the capacitive coupling between the sensing input and the P and N electrodes.

In an idle condition with no interference from an external object, the electrodes of the mutual capacitance sensitive touchpad of CIRQUE® Corporation are capacitively balanced. In other words, the capacitive coupling between all P electrodes to the sense electrode as compared to the capacitive coupling between all N electrodes to the sense electrode is equal. An object that interferes with the capacitive coupling between P and N electrodes and the sense electrode disturbs this balance. The result is either a positive value because of more coupling to P type electrodes, or a negative value because of more coupling to N type electrodes.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 42, 44 on the same rows and columns, and other factors that are not material to the present invention. The process above is repeated for the Y or column electrodes 44 using a P, N generator 24.

The touchpad circuitry has some inherent advantages as compared to the touch stick circuitry. Accordingly, it would be an advantage over the state of the art in touch stick circuitry to apply the advantages of the touchpad circuitry and thereby determine the amount of force that is being applied to the touch stick.

### BRIEF SUMMARY OF THE INVENTION

It is an object of the present invention to provide a new system and method for measuring a force applied to a strain gauge.

It is another object to apply the new system and method for measuring force to touch sticks that are commonly used in many electronic devices.

In a preferred embodiment, the present invention uses capacitance-sensitive touchpad circuitry for detecting and tracking an object on the surface of a touchpad, and provide as inputs to the touchpad circuitry the voltage divider signals from each axis of a strain gauge used as a touch stick input device, wherein the touchpad circuitry is far less sensitive to noise, and wherein touch stick control circuitry can be eliminated through the use of touchpad circuitry.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a typical prior art touch stick strain gauge measurement circuit.

FIG. 2 is a block diagram of a touchpad as taught by the prior art.

FIG. 3 is a block diagram of the circuitry of the present invention.

FIG. 4A is a conceptual circuit diagram that is representative of touchpad circuitry when measuring charge transfer from electrodes of a touchpad.

FIG. 4B is a conceptual circuit diagram that is representative of touchpad circuitry when measuring charge transfer from voltage divider circuitry of a touch stick.

FIG. 5 is a detailed circuit diagram of a touch stick circuit that is modified to include an external resistor that is used when making a measurement in the Z axis, and the measurement points for making measurements in the X, Y and Z axes.

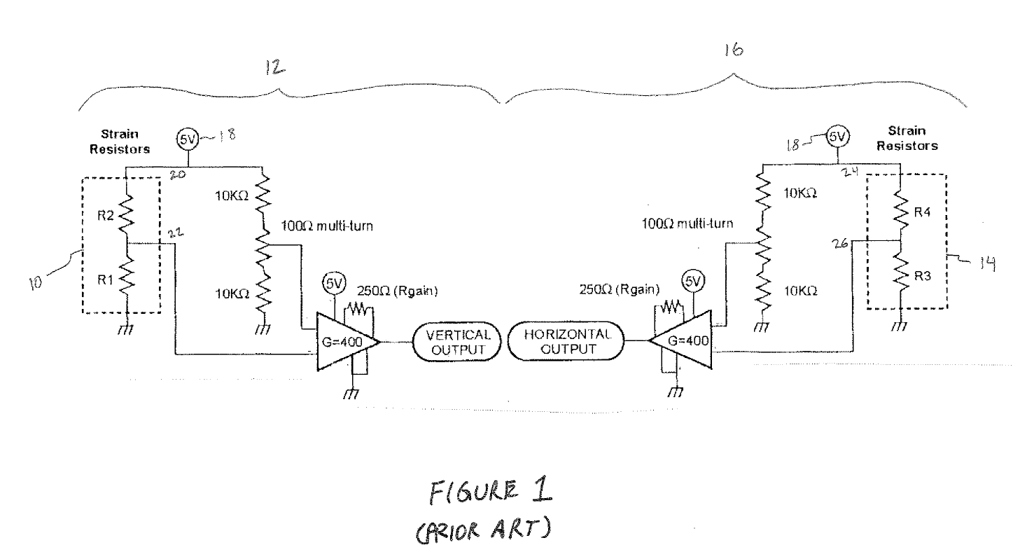

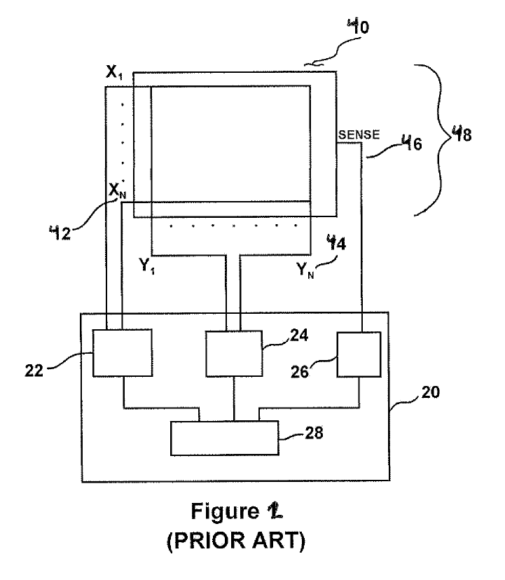

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

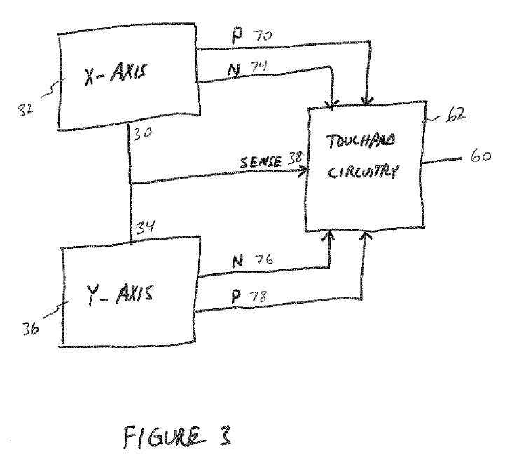

A first embodiment of the present invention is shown in FIG. 3 as a block diagram, wherein a signal 30 from an X-axis voltage divider circuit 32 is sent to a sense line input 38 of a capacitance sensitive touchpad circuit 62, and a signal 34 from a Y-axis voltage divider circuit 36 is sent to the sense line input 38 of the capacitance sensitive touchpad circuit 62. P and N signals 70, 74, 76 and 78 are also taken from the X-axis and Y-axis voltage divider circuits 32 and 36. An output signal 60 from the touchpad circuit 62 is the proportional value of the capacitive coupling between the sense electrodes and the P and N electrodes. A positive value indicates greater coupling between the P electrodes and the sense electrode, and a negative result indicates greater coupling between the N electrodes and the sense electrode.

From the output signal 60, it is possible to determine the amount of force being applied to a strain device, such as a touch stick, in both the X and Y axes. This signal can be used, for example, by a notebook computer to control the position and movement of a cursor on a display screen.

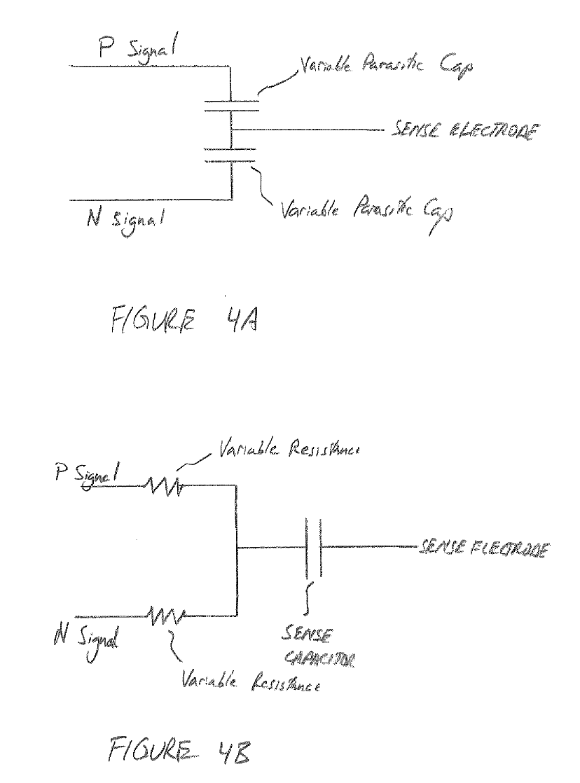

It should be understood that the system-level measurement methods for touch sticks and touchpads are different, but both methods rely on measuring the charge transfer measured by the sense electrode when P and N signals are toggled. Thus beginning with FIG. 4A, this figure is a schematic diagram that describes the nature of the circuit but not the actual circuit that exists when the touchpad circuitry is operating with a touchpad. Thus conceptually, in the touchpad measurement method, the P and N signals are coupled to the sense electrode by variable parasitic capacitors whose capacitive values are modulated by user modulation of the capacitor dielectrics. In other words, the presence of a finger enables the capacitive coupling between the P and N signals and the sense line.

When user modulation of the parasitic capacitors results in greater capacitive coupling between the P signal and the sense electrode, the resulting signal on the sense electrode is more positive. Thus, the finger is nearer to an electrode with a P signal. Likewise, when user modulation of the parasitic capacitors results in greater capacitive coupling between the N signal and the sense electrode, the resulting signal on the sense electrode is more negative.

In contrast, the conceptual circuit that is created when the touch stick is being used is different. FIG. 4B is a circuit diagram that shows that the touch stick creates a user modulated voltage divider between the P and N signals. In other words, pushing on the touch stick changes the resistance being measured in the X and Y voltage dividers. The output of the voltage dividers is then capacitively coupled to the sense electrode via a capacitive component (sense capacitor) having a static value.

For example, consider a touch stick that has a P signal in a left direction and an N signal in a right direction. If the touch stick is pushed to the left, the resistance connected to the P signal is less than the resistance connected to the N signal, and the resulting signal on the sense electrode will be more positive. The system then knows that the user is pushing the touch stick to the left. The situation is the same when the touch stick is pushed towards the right. The result will be more negative on the sense electrode.

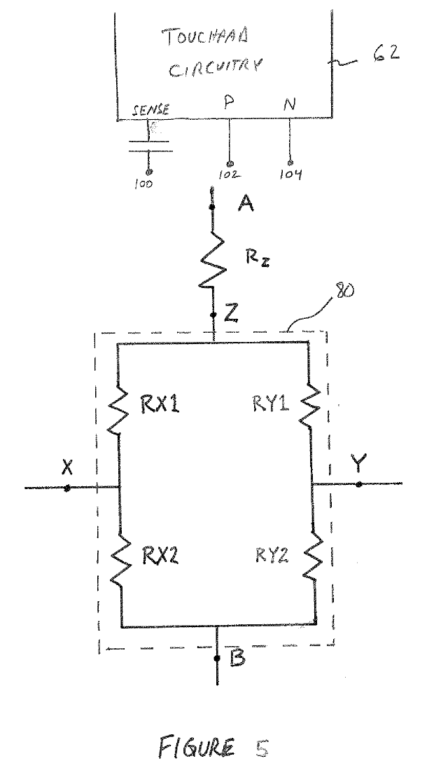

The circuit of a touch stick coupled to touchpad circuitry is now described in FIG. 5 to show more detail of the circuitry of FIG. 3, but in a schematic diagram. Before addressing the specific circuit, in general, the voltage dividing resistors of the touch stick are still used in the present invention, as these are typically a part of the touch stick apparatus itself. Therefore there is no need to design a new touch stick or modify those already existing. The same touch sticks that are presently being manufactured can be used in this first embodiment.

In FIG. 5, what is shown is the voltage divider circuitry within dashed line 80 that is already part of existing touch sticks. Signal measurements are taken from any one of five different locations on the circuit, depending on what value is being determined. To assist in understanding and summarizing the measurements, Table 1 is provided below.

TABLE 1

| | X Measurement | Y Measurement | Z Measurement |
|---|---|---|---|
| X | Sense | No Connection | No Connection |
| Y | No Connection | Sense | No Connection |
| Z | P Signal | P Signal | Sense |
| A | No Connection | No Connection | P Signal |
| B | N Signal | N Signal | N Signal |

An X measurement is a measurement that provides information regarding how hard the touch stick is being pushed relative to an X axis. In other words, the measurement determines if there is an X axis component to the force being applied to the touch stick. Similarly, a Y measurement is a measurement that provides information regarding how hard the touch stick is being pushed relative to a Y axis. Thus, this measurement determines if there is a Y axis component to the force being applied to the touch stick. It should be apparent that a force may be applied in only one axis, but is more likely to be applied in at least two axes at the same time.

According to Table 1, X is coupled to the sense 100, Y has no connection, Z has is coupled to P 102, A has no connection, and B is coupled to N 104. The connections for making a Y measurement should now be apparent from Table 1.

It should also be apparent from Table 1 that a Z measurement is also possible. A Z measurement is a measurement for determining if the touch stick is being pressed down, or if there is at least some component of force that is downward on the touch stick. A Z measurement can be used, for example, to detect what a touchpad would interpret as a tap or double tap. Constant force may also be applied to the touch stick if some type of drag gesture were to be performed.

For example, if RZ is, for example, made equal to the resistance of the touch stick resistors, or in other words, the combination of RX1 in series with RX2 in parallel with RY1 in series with RY2, then a force applied on the touch stick would result in a decrease in the resistance of the touch stick resistors, and the circuit is again a voltage divider at location Z.

It should now be apparent that using touchpad control circuitry to receive and measure signals from the touch stick is performed without having to amplify any signals coming from the touch stick resistors. Accordingly, the system is much less sensitive to noise on the signals. Furthermore, the touchpad circuitry does not have to be altered to perform the function of measuring charge transfer.

In another aspect of the present invention, the axes can be operated independently of each other. In other words, a touch stick may only operate in only one axis, either the X or Y axis. Accordingly, only RX1 and RX2 would be present in the voltage divider if only the X axis is being used.

In another alternative embodiment, a touch stick could also operate in either the X or Y axis, in combination with the Z axis.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A touch stick system that is operated by transmitting signals to a charge transfer measurement device, said touch stick system comprised of:
a first touch stick voltage divider for a first axis; and
a charge transfer measurement device coupled to the first touch stick voltage divider to thereby determine a degree of force applied to the touch stick system in the first axis.

2. The touch stick system as defined in claim 1 wherein the first touch stick voltage divider is coupled to the charge transfer measurement device at three locations.

3. The touch stick system as defined in claim 2 wherein the first touch stick voltage divider has a Z connection point at a top of said divider, an X connection point between resistors of said divider, and a B connection point at a bottom of said divider.

4. The touch stick system as defined in claim 3 wherein the touch stick system is further comprised of a second touch stick voltage divider for a second axis.

5. The touch stick system as defined in claim 4 wherein the second touch stick voltage divider is coupled to the charge transfer measurement device at three locations.

6. The touch stick system as defined in claim 5 wherein the second touch stick voltage divider has a Z connection point at a top of said divider, a Y connection point between resistors of said divider, and a B connection point at a bottom of said divider.

7. The touch stick system as defined in claim 6 wherein said system is further comprised of the first touch stick voltage divider being coupled in parallel with the second touch stick voltage divider.

8. The touch stick system as defined in claim 7 wherein the charge transfer measurement device is further comprised of a positive signal input, a negative signal input, and a sense input.

9. The touch stick system as defined in claim 8 wherein to make a measurement relative to the first axis, the X connection point is coupled to the sense input, the Z connection point is coupled to the positive signal input, and the B connection point is coupled to the negative signal input.

10. The touch stick system as defined in claim 8 wherein to make a measurement relative to the first axis, the X connection point is coupled to the sense input, the Z connection point is coupled to the negative signal input, and the B connection point is coupled to the positive signal input.

11. The touch stick system as defined in claim 8 wherein to make a measurement relative to the second axis, the Y connection point is coupled to the sense input, the Z connection point is coupled to the positive signal input, and the B connection point is coupled to the negative signal input.

12. The touch stick system as defined in claim 8 wherein to make a measurement relative to the second axis, the X connection point is coupled to the sense input, the Z connection point is coupled to the positive signal input, and the B connection point is coupled to the negative signal input.

13. The touch stick system as defined in claim 8 wherein the touch stick system is further comprised of a third touch stick voltage divider for a third axis that is orthogonal to the first and second axes.

14. The touch stick system as defined in claim 13 wherein the third touch stick voltage divider is comprised of a top resistance that is comprised of a resistor that is external to the touch stick system, wherein the bottom resistance is a combination of the first touch stick voltage divider and the second touch stick voltage divider.

15. The touch stick system as defined in claim 14 wherein the Z connection point is coupled to the sense input, an A connection point above the top resistance is coupled to the positive input signal, and the B connection point is coupled to the negative input signal.

16. The touch stick system as defined in claim 14 wherein the Z connection point is coupled to the sense input, an A connection point above the top resistance is coupled to the negative input signal, and the B connection point is coupled to the positive input signal.

17. A measurement system for determining the amount of force applied to a strain gauge, said measurement system comprised of:
a first strain gauge voltage divider for a first axis; and
a charge transfer measurement device coupled to the first strain gauge voltage divider to thereby determine a degree of force applied to the first strain gauge voltage divider in the first axis.

18. A method for measuring the amount of force applied to a touch stick, said method comprising the steps of:
1) providing a first touch stick voltage divider for a first axis and a charge transfer measurement device that is coupled to the first touch stick voltage divider; and
2) determining a degree of force applied to the touch stick system in the first axis by measuring a charge that is transferred to the first touch stick voltage divider.

19. The method as defined in claim 18 wherein the method further comprises the step of providing a positive and a negative signal from the first touch stick voltage divider to the charge transfer measurement device.

20. The method as defined in claim 19 wherein the method is further comprised of the step of capacitively coupling an output of the first touch stick voltage divider to a sense input of the charge transfer measurement device.

21. The method as defined in claim 19 wherein the method is further comprised of the step of modulating a resistance of the first touch stick voltage divider to thereby enable the charge transfer measurement device to determine in which direction a force is being applied along the first axis.
